(19) United States
(12) Patent Application Publication
(10) Pub. No.: US 2015/0081568 A1
(43) Pub. Date: Mar. 19, 2015

(54) DEALER PORTAL DEVICE ENROLLMENT

(71) Applicant: Ingersoll-Rand Company, Davidson, NC (US)

(72) Inventor: Joseph George Land III, Tyler, TX (US)

(21) Appl. No.: 14/332,221

(22) Filed: Jul. 15, 2014

Related U.S. Application Data
(60) Provisional application No. 61/846,483, filed on Jul. 15, 2013.

(51) Int. Cl. G06Q 30/00

(52) U.S. Cl. CPC G06Q 30/016
USPC 705/304

(57) ABSTRACT

A server may receive an opt-in or an opt-out request from a customer device. The opt-in request allows a registered dealer device to view and control settings on a sensor/actuator at a customer site. The server may provide a graphical user interface to the dealer device. The graphical user interface is structured to allow the registered dealer device to view and control settings of the sensor/actuator. The server may be structured to receive changes to the settings of the sensor/actuator from the registered dealer device via the graphical user interface and to then change the settings of the sensor/actuator.

### CROSS-REFERENCE TO RELATED APPLICATIONS

The present application claims the benefit of U.S. Provisional Patent Application No. 61/846,483, filed on Jul. 15, 2013, which is hereby incorporated by reference in its entirety.

### BACKGROUND

The present application generally relates to an enrollment system and in particular, a dealer portal enrollment system. Enrollment systems may be structured to operate in various ways. Some existing systems have various shortcomings relative to certain applications. Accordingly, there remains an interest for further contributions in this area of technology.

### SUMMARY

One embodiment of the present invention is a unique enrollment system. Other embodiments include apparatuses, systems, devices, hardware, methods, and combinations for an enrollment system. Further embodiments, forms, features, aspects, benefits, and advantages of the present application shall become apparent from the description and figures provided herewith.

### BRIEF DESCRIPTION OF THE FIGURES

The description herein makes reference to the accompanying figures wherein like reference numerals refer to like parts throughout the several views, and wherein:

FIG. 1 is a schematic diagram of an exemplary system.

FIG. 2 is a schematic diagram of an exemplary computing device.

FIG. 3 is a schematic flow diagram for an exemplary process.

FIG. 4 is a schematic flow diagram for an exemplary process.

FIG. 5 is a schematic diagram of exemplary sensors and/or actuators.

### DETAILED DESCRIPTION OF THE ILLUSTRATIVE EMBODIMENTS

For the purposes of promoting an understanding of the principles of the present invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

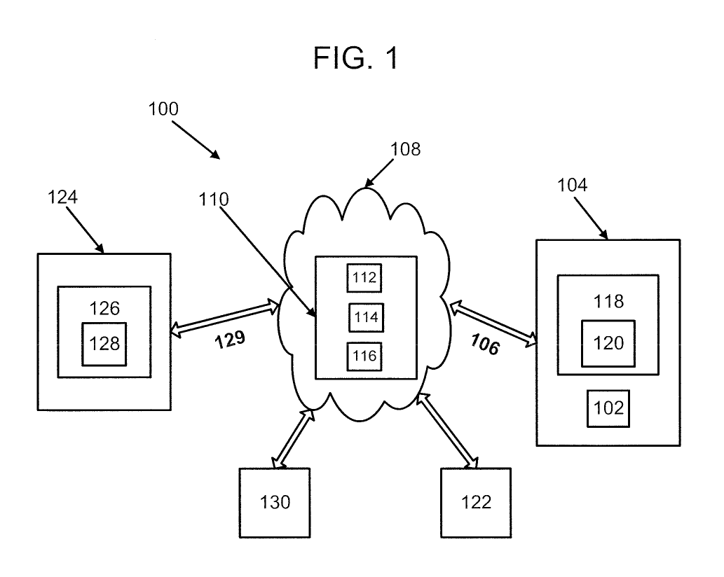

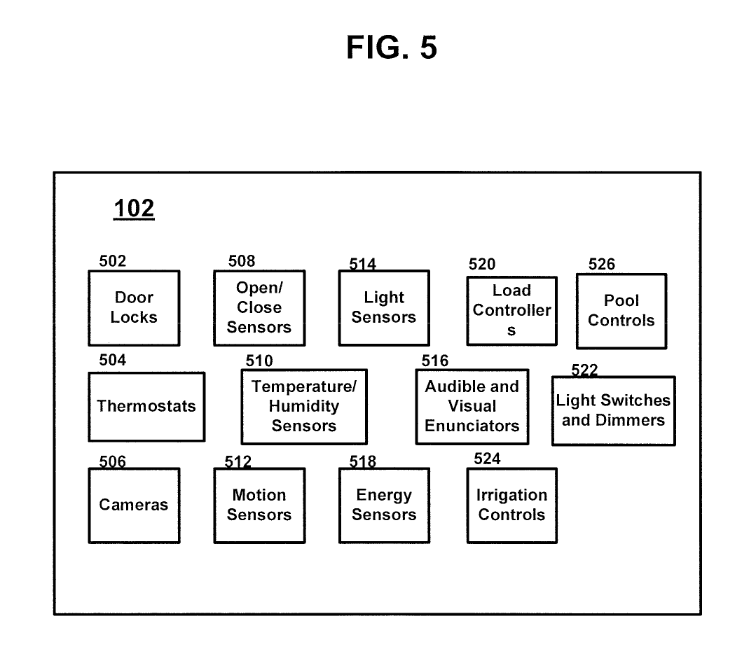

The present application generally relates to a system for allowing a dealer to remotely access and/or control a device in a customer's home. FIG. 1 is a schematic diagram of a system 100 for registering and/or providing control over one or more sensors and/or actuators 102 in a building 104 such as a home. The system 100 includes one or more sensors/actuators 102 that measure and/or regulate or control various parameters in the building 104. The sensors/actuators 102 may be located in various spaces in and around the building 104 such as in bedrooms, bathrooms, family rooms, living rooms, kitchens, basements, dining rooms, outside patio, garage, yard, driveway, common area, and the like. The sensors/actuators 102 may include light controls, electronic locks, thermostats, cameras, and the like as seen in FIG. 5.

The sensors/actuators 102 may form a network in the building 104. The network may be a Z-Wave wireless mesh network, a Zigbee wireless mesh network, an 802.11 wireless network, TCP/IP over Ethernet, a proprietary radio protocol, a proprietary wired communication protocol, the Trane Comfort Link II wired communication protocol, the Internet, NFC, Bluetooth, or any other suitable communication channel.

The sensors/actuators 102 may be configured and/or controlled remotely. For example, the system 100 includes a communication channel 106 for transferring information (either one-way or bi-directionally) from the sensors/actuators 102 to a cloud service 108 and from the cloud service 108 to the sensors/actuators 102. The communication channel 106 may be the Internet or any other appropriate communication channel. The sensors/actuators 102 may communicate with the cloud service 108 over the Internet or any other communication channel via, e.g., a bridge and/or router (not shown), to receive settings and/or report information. Moreover, the sensors/actuators 102 include appropriate circuitry and/or firmware/software that allows the sensors/actuators 102 to communicate with the cloud service 108 via, e.g., a bridge and/or router. The cloud service 108 provides various services for controlling and managing the sensors/actuators 102. The cloud service 108 includes a server and database 110 to store customer opt-in information, dealer registration information, control rules, and/or sensor/actuator settings, among other settings.

The server 110 may also include one or more applications 112 that provide a customer account module 114 and/or a dealer portal module 116. Generally, the customer account module 114 may provide a graphical user interface that provides the customer with information and allows the customer to interact with the customer account module 114 to manage, monitor, set-up and/or control sensors/actuators 102 at the building 104. Generally, the dealer portal module 116 allows dealers to diagnose and correct any problems with a customer's sensor/actuator 102 remotely rather than the dealer driving to the customer's building (e.g., a home) to configure or install the sensor/actuator or investigate complaints. The dealer may use the dealer portal module 116 where the dealer will be able to view and/or control live system information remotely after the sensor/actuator 102 (e.g., a thermostat) has been properly authorized by the owner for viewing by that dealer.

A customer at the building 104 may use a computer 118 that may include an application 120 for controlling the sensor/actuators 102 at the building 104. The application 120 may communicate with the customer account module 114 at the cloud service 108 to monitor and/or control the sensors/actuators 102 through the communication channel 106 or any other communication channel. A mobile device 122 may communicate with the customer account module 114 at the cloud service 108 to monitor and/or control the sensors/actuators 102 over a wireless network and/or the Internet.

A dealer at a dealer site 124 may use a computer 126 that includes an application 128 for communicating with the dealer portal module 116 at the cloud service 108 via a communication channel 129 such as the Internet or any other appropriate communication network. Generally, the dealer portal module 116 may provide a graphical user interface that provides the customer with information to monitor and/or control the sensors/actuators 102 at the customer site 104. A mobile device 130 may communicate with the dealer portal module 116 at the cloud service 108 to monitor and/or control the sensors/actuators 102 over a wireless network and/or the Internet.

Generally, the application 112, including customer account module 114 and dealer portal module 116, provides that dealers can only see data for sensors/actuators 102 for which the dealer has installed and the customer has authorized the dealer to view. In addition, the customer may verify which dealer has access, limit access to a single dealer or multiple dealers, and/or provide temporary access to the dealer for making remote modifications to the sensor/actuator 102.

Once a sensor/actuator 102 is authorized for dealer data access, customers have the option of granting temporary control rights to the dealer via the customer account module 114 so that the dealer can remotely adjust the sensor/actuator 102 (e.g., a thermostat) via the dealer portal module 116 during a defined period of access rights. The system 100 may be preconfigured for passive opt-in by default so that the customer does not have proactively look up the specific dealer for granting access. In addition, during the initial installation before a customer account is created, a dealer may gain temporary remote access to the sensor/actuator 102 for initial setup and troubleshooting.

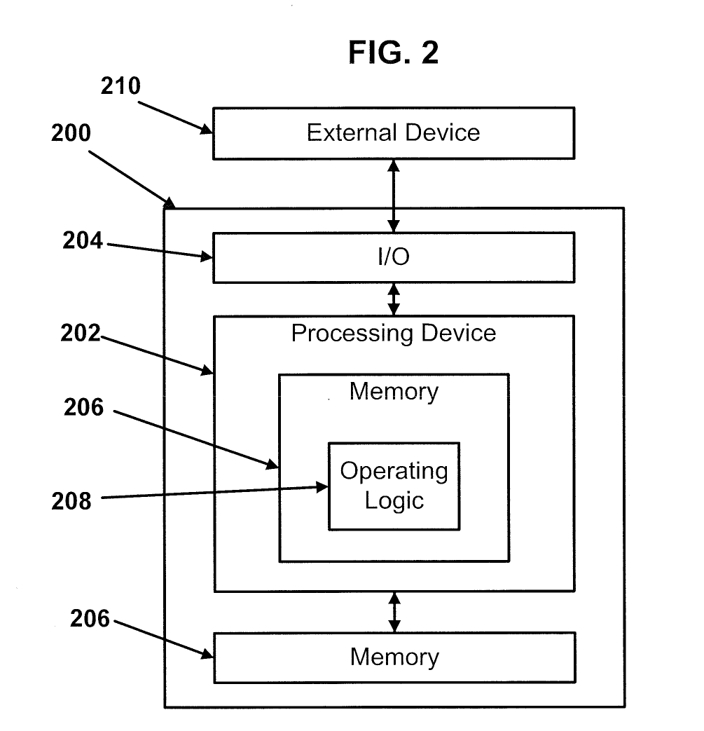

FIG. 2 is a schematic diagram of a computing device 200. The computing device 200 is one example of a sensor/actuator, computer, server/database, and/or mobile device which may be utilized in connection with the sensor/actuators 102, computers 118, 126, the server and/or database 110, and/or mobile devices 122, 130 shown in FIG. 1. Computing device 200 includes a processing device 202, an input/output device 204, memory 206, and operating logic 208. Furthermore, computing device 200 may communicate with one or more external devices 210.

The input/output device 204 may be any type of device that allows the computing device 200 to communicate with the external device 210. For example, the input/output device 204 may be a transceiver (e.g., Z-Wave, Zigbee, WIFI, NFC, Bluetooth), network adapter, network card, interface, or a port (e.g., a USB port, serial port, parallel port, an analog port, a digital port, VGA, DVI, HDMI, FireWire, CAT 5, or any other type of port or interface). The input/output device 204 may be comprised of hardware, software, firmware, and/or state machines. It is contemplated that the input/output device 204 may include more than one transceiver, network adapter, network card, or port.

The external device 210 may be any type of device that allows data to be inputted to or outputted from the computing device 200. For example, the external device 210 may be a control device, transceiver, a mobile device (e.g., a smartphone), an accessory, a reader device, equipment, a handheld computer, a diagnostic tool, a controller, a computer, a server, a processing system, a sensor, a printer, a display, an alarm, an illuminated indicator such as a status indicator, a keyboard, a mouse, or a touch screen display. Furthermore, it is contemplated that the external device 210 may be integrated into the computing device 200. For example, the computing device 200 may be a mobile phone, controller, a handheld diagnostic tool, a smartphone, a laptop computer, or a tablet computer in which case the display would be an external device 210, but the display is integrated with the computing device 200 as one unit, which is consistent with the general design of mobile phones, handheld diagnostic tools, smartphones, laptop computers, tablet computers, and the like. It is further contemplated that there may be more than one external device in communication with the computing device 200.

Processing device 202 can be a programmable type, a dedicated, hardwired state machine; or a combination of these; and it can further include multiple processors, Arithmetic-Logic Units (ALUs), Central Processing Units (CPUs), Digital Signal Processors (DSPs), or the like. Processing devices 202 with multiple processing units may utilize distributed, pipelined, and/or parallel processing. Processing device 202 may be dedicated to performance of just the operations described herein or may be utilized in one or more additional applications. In the depicted form, processing device 202 is of a programmable variety that executes algorithms and processes data in accordance with operating logic 208 as defined by programming instructions (such as software or firmware) stored in memory 206. Alternatively or additionally, operating logic 208 for processing device 202 is at least partially defined by hardwired logic or other hardware. Processing device 202 can be comprised of one or more components of any type suitable to process the signals received from input/output device 204 or elsewhere, and provide desired output signals. Such components may include digital circuitry, analog circuitry, or a combination of both.

Memory 206 may be of one or more types, such as a solid-state variety, electromagnetic variety, optical variety, or a combination of these forms. Furthermore, memory 206 can be volatile, nonvolatile, or a mixture of these types, and some or all of memory 206 can be of a portable variety, such as a disk, tape, memory stick, cartridge, or the like. In addition, memory 206 can store data that is manipulated by the operating logic 208 of processing device 202, such as data representative of signals received from and/or sent to input/output device 204 in addition to or in lieu of storing programming instructions defining operating logic 208, just to name one example. As shown in FIG. 2, memory 206 may be included with processing device 202 and/or coupled to the processing device 202.

As described above, the system 100 includes one or more modules 114, 116 that may be part of one or more processing devices 202 (server and/or database 110 in the cloud service 108) or be standalone computing devices. A module may be implemented in operating logic 208 as operations by software, hardware, artificial intelligence, fuzzy logic, or any combination thereof, or at least partially performed by a user or operator. In certain embodiments, modules represent software elements as a computer program encoded on a computer readable medium, wherein a computer performs the described operations when executing the computer program. A module may be a single device, distributed across devices, and/or a module may be grouped in whole or in part with other modules or devices. The operations of any module may be performed wholly or partially in hardware/software or by other module. The presented organization of the modules is exemplary only, and other organizations, configurations and arrangements are contemplated.

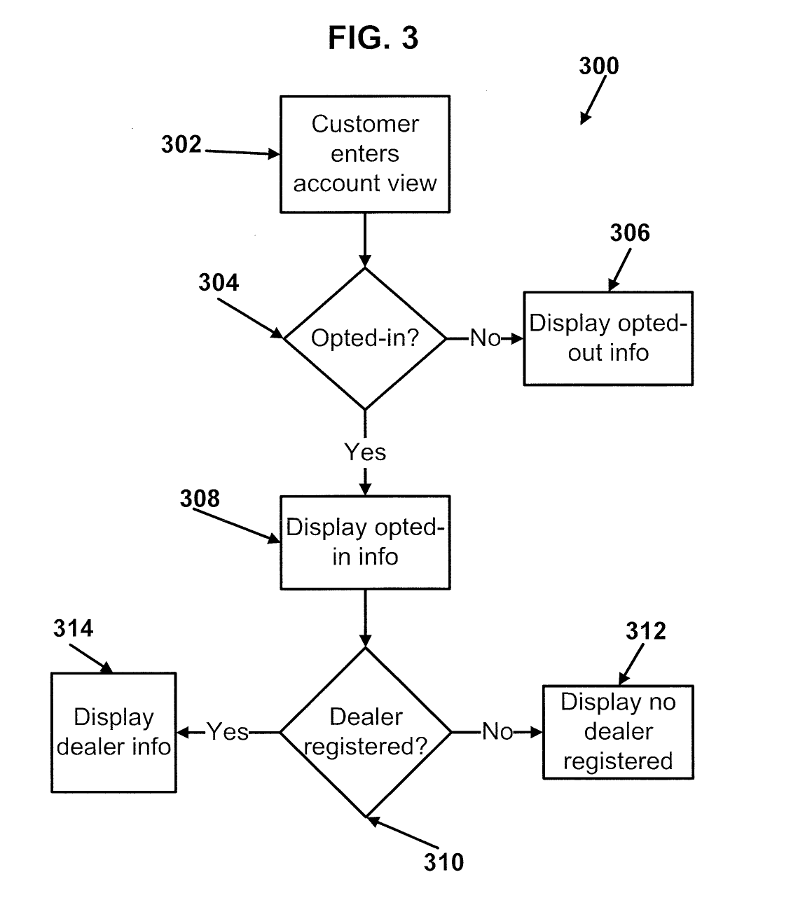

FIG. 3 illustrates a schematic flow diagram of an exemplary process 300 for a customer to grant a dealer access to a sensor and/or actuator. Operations illustrated for all of the processes in the present application are understood to be examples only, and operations may be combined or divided, and added or removed, as well as re-ordered in whole or in part, unless explicitly stated to the contrary.

Process 300 begins at operation 302 in which a customer using computer 118 or mobile device 122 enters a view of his or her account through the customer account module 114. In this view, the customer may enroll a sensor/actuator 102 into the customer's account by entering a unique identifier (UID) associated with the sensor/actuator 102. The customer account module 114 may provide other information and options for the customer.

Process 300 then proceeds from operation 302 to operation 304. At operation 304, the customer account module 114 provides an interface for the customer to opt-in or opt-out with respect to a dealer having access to the sensor/actuator 102. The customer account module 114 may display whether the customer has previously selected to opt-in or to opt-out and whether the customer would like to change that selection. If the customer selects opt-out, process 300 proceeds from operation 304 to operation 306 in which the customer account module 114 displays text and/or other information related to the opt-out by the customer. If the customer selects opt-in, process 300 proceeds from operation 304 to operation 308. At operation 308, the customer account module 114 displays text and/or other information about the customer's opt-in. The opt-in may be determined on a sensor/actuator-by-sensor/actuator basis or be determined on an account-by-account basis (e.g., every sensor/actuator associated with the account is opt-in based on one selection). The customer may set these opt-in control rules in the customer account module 114.

Process 300 then proceeds from operation 308 to operation 310 in which the customer account module 114 determines whether the dealer is registered. The customer account module 114 may make this determination by determining whether a dealer is associated with the particular UID or the customer may search for a particular dealer through the interface provided by the customer account module 114. If the dealer is not registered, process 300 proceeds from operation 310 to operation 312 in which text and/or other information is displayed relating to the fact that the dealer is not registered. For example, the customer account module 114 may display, “No dealer has registered to provide remote diagnostic services. Contact your dealer for assistance.”

If the dealer is registered, process 300 proceeds from operation 310 to operation 314 in which the customer account module 314 displays the dealer information and/or an interface to configure dealer access rights, among other data. For example, the customer account module 114 may display “Click here for dealer contact information,” which when clicked will display the registered dealer's name, contact information, business logo, and the like.

Furthermore, at operation 314, once a sensor/actuator 102 is authorized for dealer data access, the customer has the option of granting temporary and/or persistent control rights to the dealer via the customer account module 114 so that the dealer can remotely adjust and/or configure the sensor/actuator 102 during the defined period of access rights. Through the interface provided by the customer account module 114, the customer may click a button to enable dealer control for a defined time period (e.g., between 1 and 24 hours) after which dealer control rights automatically expire. During the time period where dealer control is active, graphic elements are highlighted to remind the customer that the system is currently open for dealer control.

In some embodiments, during the initial installation, the dealer may be able to remotely access and control the sensor/actuator 102 while the sensor/actuator 102 is set in a defined installation mode without a customer opting-in.

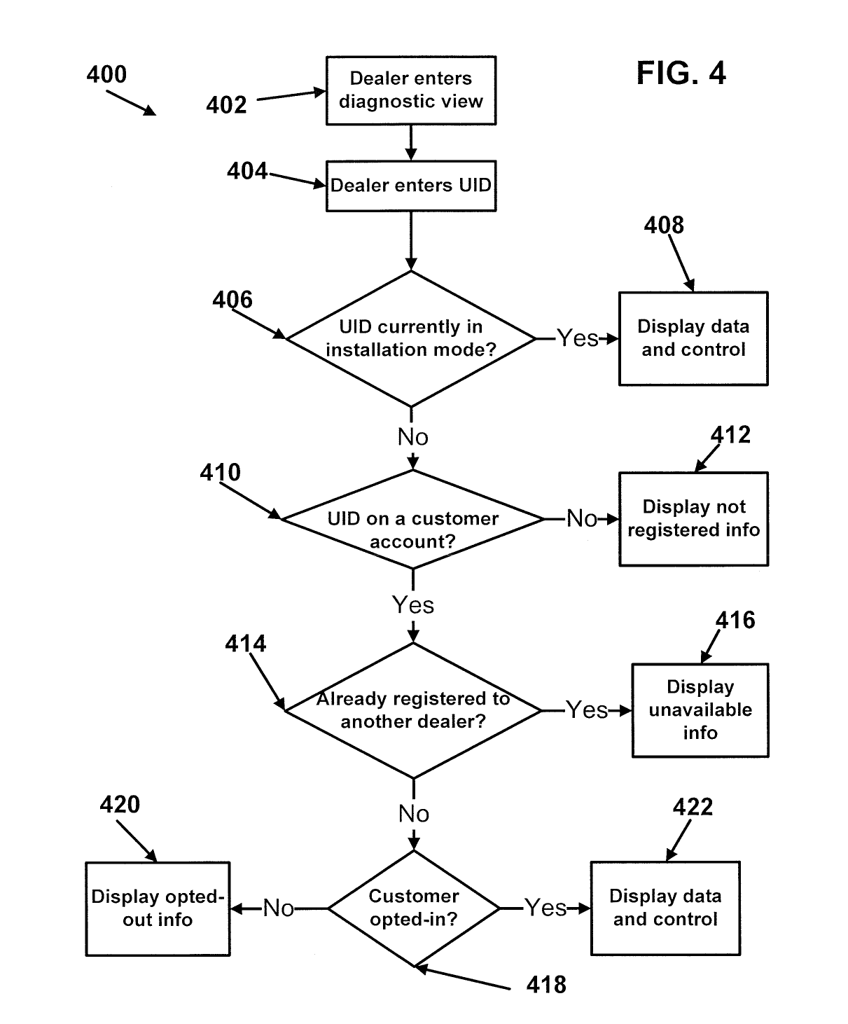

FIG. 4 illustrates a schematic flow diagram of an exemplary process 400 for a dealer to access and/or control one or more sensor/actuators 102 at a customer site 104. Process 400 begins at operation 402 in which a dealer using computer 126 or mobile device 130 enters a diagnostic view through the dealer portal module 116. In the dealer view, the dealer portal module 116 provides the dealer with information about the dealer's various customers.

Process 400 then proceeds from operation 402 to operation 404. At operation 404, the dealer may enter a UID into the dealer portal module 116 for a particular sensor/actuator 102 installed and/or sold by the dealer. Process 400 then proceeds from operation 404 to operation 406. At operation 406, the dealer portal module 116 determines whether the sensor/actuator 102 associated with the UID is currently in installation mode.

If the sensor/actuator 102 associated with the UID is currently in installation mode, the process 400 proceeds from operation 406 to operation 408. At operation 408, the dealer portal module 116 displays diagnostic data and/or control capabilities for the sensor/actuator 102. In order to facilitate initial installation, the sensor/actuator 102 is configured such that within the installers menu there is an option to temporarily enable remote diagnostics and control by the registered dealer. In some embodiments, this mode automatically expires after a predetermined period (e.g., 1 to 4 hours) and does not require any type of customer opt-in. During the period where installation services are enabled, the sensor/actuator 102 itself may graphically represent that this mode is active. In addition, during this period, the dealer may configure and/or adjust settings on the sensor/actuator 102.

If the sensor/actuator 102 associated with the UID is not currently in installation mode, then process 400 proceeds from operation 406 to operation 410. At operation 410, the dealer portal module 116 determines whether the UID is associated with or entered into an active customer account. If the UID is not associated with or entered into an active customer account, then process 400 proceeds from operation 410 to operation 412 in which a status such as “Not Registered,” is displayed. If the UID is associated with or entered into an active customer account, then process 400 proceeds from operation 410 to operation 414.

At operation 414, the dealer portal module 116 determines whether the sensor/actuator 102 is registered to another dealer based on the UID. If the sensor/actuator 102 is registered to another dealer, then process 400 proceeds from operation 414 to operation 416 in which a status such as “Unavailable,” is displayed. If the sensor/actuator 102 is not registered to another dealer, then process 400 proceeds from operation 416 to operation 418.

At operation 418, the dealer portal module 116 determines whether the customer has opted-in. If the customer has not opted-in, then process 400 proceeds from operation 418 to operation 420 in which a status such as “Opted-out,” is displayed and no access to data and/or controls is allowed. If the customer opted-in, then process 400 proceeds from operation 418 to operation 422 in which the dealer is allowed access to the data and/or control of the settings of the sensor/actuator 102 associated with the UID. In some embodiments, the UID is placed on the dealer's dashboard list in the dealer portal module 116 for quick access in the future. Generally, while viewing data for a sensor/actuator 102 fully authorized for data access, the dealer may see graphic elements which allow for the modification of various sensor/actuator 102 settings. These elements may be grayed out or similarly illustrate being non-functional except during the time period while temporary and/or persistent control has been granted. During those periods, the visual appearance on the dealer view will change to indicate control rights are currently active. It is contemplated that any changes that the dealer makes may be automatically logged in the customer view for auditing and review purposes.

The various aspects of the processes 300 and 400 in the present application may be implemented in operating logic 208 as operations by software, hardware, artificial intelligence, fuzzy logic, or any combination thereof, or at least partially performed by a user or operator. In certain embodiments, operations represent software elements as a computer program encoded on a computer readable medium, wherein the server 110 performs at least some of the described operations when executing the computer program.

FIG. 5 illustrates the various types sensors/actuators 102, including but not limited to, door locks 502, thermostats 504, cameras 506, open/close sensors 508, temperature/humidity sensors 510, motion sensors 512, light sensors 514, audible and visual enunciators 516, energy sensors 518, load controllers 520, light switches and dimmers 522, irrigation controls 524, pool controls 526, or any other suitable sensor or actuator. It is contemplated that other sensors and/or actuators 102 may be used in the system 100.

One aspect of the present application may include a method, comprising: receiving, at a server, one of an opt-in request and an opt-out request from a customer device, wherein the opt-in request allows a registered dealer device to view and control settings on at least one of a plurality of sensors/actuators at a customer site, wherein the sensors/actuators are part of a home automation system; receiving, at the server, dealer access right configuration data from the customer device, wherein the dealer access right configuration data defines whether the registered dealer device is allowed to view and control settings on at least one of a plurality of sensors/actuators at a customer site; determining, with the server, whether the registered dealer device is allowed to access and control the sensors/actuators at the customer site; in response to determining that the registered dealer device is allowed to access and control the sensors/actuators at the customer site, providing a graphical user interface to the registered dealer device, wherein the graphical user interface is structured to allow the registered dealer device to view and control settings to at least one of the sensors/actuators; receiving, with the server, changes to the settings of at least one of the sensors/actuators from the registered dealer device via the graphical user interface; and changing the settings of at least one of the sensors/actuators with the server.

Features of the aspect of the present application may include: wherein the opt-in request may be based on a sensor/actuator-by-sensor/actuator basis or be based on an account-by-account basis; wherein the dealer access right configuration data defines whether the customer device has granted temporary or persistent control rights; wherein the registered dealer device has control rights during an installation mode of at least one of the sensors/actuators.

The present invention may be implemented on any type of computer and using a variety of different software. For example, the present application may be implemented using Microsoft Excel, Microsoft Access, Microsoft SQL Server, any of Oracle's database systems, MySQL, custom software modules, custom databases, any other appropriate software or database, or any combination thereof. When the computer or storage system is configured as a database, it is contemplated that the database may be any type of database, such as relational, hierarchical, object-oriented, and/or the like.

A computer readable medium may refer to any tangible storage and/or transmission medium that participate in providing instructions to a processing device for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. When the language “at least a portion” and/or “a portion” is used the item can include a portion and/or the entire item unless specifically stated to the contrary.

What is claimed is:

1. A method, comprising:
receiving, at a server, one of an opt-in request and an opt-out request from a customer device, wherein the opt-in request allows a registered dealer device to view and control settings on at least one of a plurality of sensors/actuators at a customer site, wherein the sensors/actuators are part of a home automation system;
receiving, at the server, dealer access right configuration data from the customer device, wherein the dealer access right configuration data defines whether the registered dealer device is allowed to view and control settings on at least one of a plurality of sensors/actuators at a customer site;
determining, with the server, whether the registered dealer device is allowed to access and control the sensors/actuators at the customer site;
in response to determining that the registered dealer device is allowed to access and control the sensors/actuators at the customer site, providing a graphical user interface to the registered dealer device, wherein the graphical user interface is structured to allow the registered dealer device to view and control settings to at least one of the sensors/actuators;
receiving, with the server, changes to the settings of at least one of the sensors/actuators from the registered dealer device via the graphical user interface; and
changing the settings of at least one of the sensors/actuators with the server.

2. The method of claim 1, wherein the opt-in request may be based on a sensor/actuator-by-sensor/actuator basis or be based on an account-by-account basis.

3. A system including a server structured to implement the method of claim 1.

4. The method of claim 1, wherein the dealer access right configuration data defines whether the customer device has granted temporary or persistent control rights.

5. The method of claim 1, wherein the registered dealer device has control rights during an installation mode of at least one of the sensors/actuators.
